(19) United States
(12) Patent Application Publication
(10) Pub. No.: US 2010/0226151 A1
(43) Pub. Date: Sep. 9, 2010

(54) POWER CONVERSION CIRCUIT AND PORTABLE POWER SUPPLY HAVING SUCH POWER CONVERSION CIRCUIT

(76) Inventors: Chin-Hou Chen, Taoyuan Hsien (TW); Chia-Lung Ni, Taoyuan Hsien (TW); Wen-Sheng Tsao, Taoyuan Hsien (TW); Ku-Yu Hsiao, Taoyuan Hsien (TW)

Correspondence Address: AUSTIN RAPP & HARDMAN, 170 South Main Street, Suite 735, SALT LAKE CITY, UT, 84101, US

(21) Appl. No.: 12/686,194

(22) Filed: Jan. 12, 2010

(30) Foreign Application Priority Data
Mar. 9, 2009 (TW) 098107594

(51) Int. Cl. H02M 3/335

(52) U.S. Cl. 363/21.12

(57) ABSTRACT

A power conversion circuit includes a flyback DC-to-DC converter, a capacitor and a DC-to-AC converter. The flyback DC-to-DC converter is used for receiving an input DC voltage and converting the input DC voltage into a constant high DC voltage. The capacitor is connected to the flyback DC-to-DC converter for filtering the high DC voltage. The DC-to-AC converter is connected to the capacitor for converting the filtered high DC voltage into an output AC voltage.

### CLAIM OF PRIORITY

This application claims priority to Taiwanese Patent Application No. 098107594 filed on Mar. 9, 2009.

### FIELD OF THE INVENTION

The present invention relates to a power conversion circuit, and more particularly to a power conversion circuit for reducing power loss. The present invention also relates to a portable power supply having such a power conversion circuit.

### BACKGROUND OF THE INVENTION

An inverter is a power converter for converting a DC voltage into an AC voltage. The inverter can be applied at any instance where a DC power source is available. Generally, the inverter is used in a vehicle or a portable DC battery. After the DC voltage supplied from the vehicle or the portable DC battery is converted into an AC voltage by the inverter, a proper DC-to-DC converter can be electrically connected to the inverter so as to convert the AC voltage into a regulated DC voltage required for a corresponding portable electronic device, e.g. a notebook computer, a mobile phone, a MP3 portable player, a camera or a lamp. Alternatively, the AC voltage outputted from the inverter can be used for some emergency security purposes. In other words, by means of the inverter, the portable electronic device can be used in some places where no external power source is available.

A conventional inverter has a push pull DC-to-DC converter for converting the input DC voltage into a high DC voltage. The high DC voltage is then converted into a modified AC voltage by a full bridge DC-to-AC converter. The modified AC voltage is outputted from the full bridge DC-to-AC converter to power the load that is connected thereto.

Although the push pull DC-to-DC converter and the full bridge DC-to-AC converter of the inverter are able to produce the modified AC voltage required for powering the load, there are still some drawbacks. For example, the push pull DC-to-DC converter has two switch elements alternately conducted so as to output the high DC voltage from the secondary side. In addition, a rectifier circuit consisted of four diodes are disposed at the secondary side in order to rectify the high DC voltage. In other words, the inverter needs two main switch elements, a transformer with two primary winding assemblies and a secondary winding assembly, and four rectifier diodes. Under this circumstance, the inverter has complicated circuitry layout, bulky volume and high fabricating cost.

Moreover, since the input DC voltage at the primary side of the push pull DC-to-DC converter and the high DC voltage at the secondary side of the push pull DC-to-DC converter are equal to the turn ratio of the primary side to the secondary side, the peak value of the modified AC voltage is substantially in proportion to the input DC voltage. In other words, if the range of the input DC voltage is too broad, the variation of the modified AC voltage is very large, which is detrimental to the load.

Moreover, since the duty cycle of the push pull DC-to-DC converter is fixed, unnecessary electric energy is consumed even when the push pull DC-to-DC converter is at light-loading or no-loading state. Under this circumstance, the power loss is increased.

Moreover, since the high DC voltage transmitted from the push pull DC-to-DC converter is usually altered with a change of the input DC voltage, the AC voltage outputted from the full bridge DC-to-AC converter will be altered with the change of the input DC voltage.

For solving the above drawbacks, some literatures disclose a method of feedback controlling the duty cycle of the push pull DC-to-DC converter according to the magnitude of the modified AC voltage. Such method is able to reduce the output AC voltage to prevent from damage of the load when the input DC voltage is high. Such method, however, has a complicated feedback control mechanism and a slow response speed, and thus fails to provide desirable power quality.

For increasing the response speed and enhancing the power quality, some literatures disclose another method of controlling the duty cycle of the full bridge DC-to-AC converter according to the magnitude of the high DC voltage, so that the modified AC voltage is maintained constant. Such method, however, still has a complicated feedback control mechanism. In addition, the response speed and the power quality are still unsatisfactory.

There is a need of providing a power conversion circuit so as to obviate the drawbacks encountered from the prior art.

### SUMMARY OF THE INVENTION

It is an object of the present invention to provide a power conversion circuit with less number of electronic components in order to reduce the fabricating cost.

Another object of the present invention provides a power conversion circuit having a simplified control mechanism and reduced power loss.

A further object of the present invention provides a portable power supply having such a power conversion circuit.

In accordance with an aspect of the present invention, there is provided a power conversion circuit. The power conversion circuit includes a flyback DC-to-DC converter, a capacitor and a DC-to-AC converter. The flyback DC-to-DC converter is used for receiving an input DC voltage and converting the input DC voltage into a constant high DC voltage. The capacitor is connected to the flyback DC-to-DC converter for filtering the high DC voltage. The DC-to-AC converter is connected to the capacitor for converting the filtered high DC voltage into an output AC voltage.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram of a power conversion circuit according to an embodiment of the present invention;

FIG. 2 is a schematic detailed circuit diagram of the power conversion circuit as shown in FIG. 1;

FIG. 3 is a timing waveform diagram illustrating related voltage signals processed in the power conversion circuit as shown in FIG. 2; and

FIG. 4 is a schematic circuit block diagram illustrating a portable power supply having a power conversion circuit of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

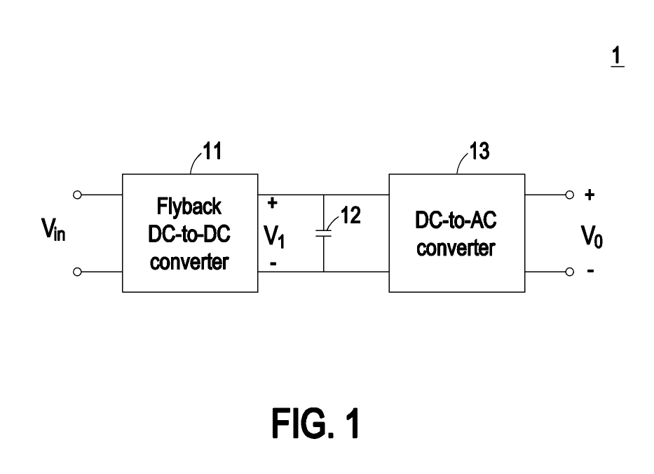

FIG. 1 is a schematic circuit block diagram of a power conversion circuit according to an embodiment of the present invention. The power conversion circuit 1 is used for converting an input DC voltage Vᵢₙ into an output AC voltage Vₒ for powering a load that is connected to the power conversion circuit. As shown in FIG. 1, the power conversion circuit 1 principally comprises a flyback DC-to-DC converter 11, a capacitor 12 and a DC-to-AC converter 13. By the flyback DC-to-DC converter 11, the input DC voltage Vᵢₙ is converted into a constant high DC voltage V₁. The capacitor 12 is connected to the output terminals of the flyback DC-to-DC converter 11 and the input terminals of the DC-to-AC converter 13 for filtering the high DC voltage V₁. The filtered high DC voltage V₁ is converted by the DC-to-AC converter 13 into the output AC voltage Vₒ.

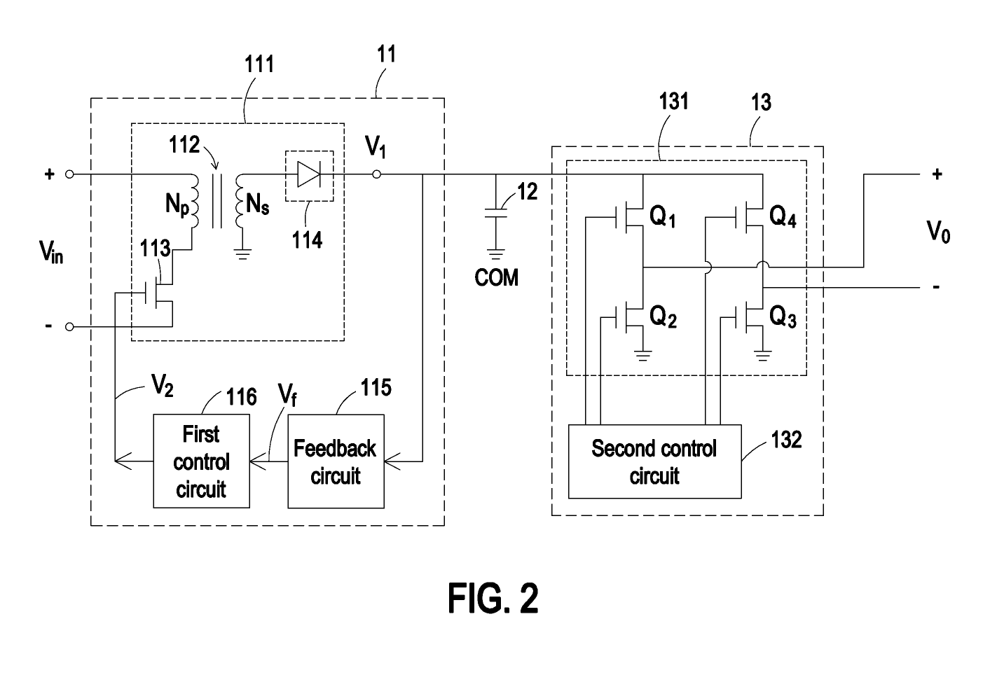

FIG. 2 is a schematic detailed circuit diagram of the power conversion circuit as shown in FIG. 1. As shown in FIG. 2, the flyback DC-to-DC converter 11 includes a first-stage power circuit 111. The first-stage power circuit 111 includes a transformer 112, a first switch element 113 and a rectifier circuit 114. The primary side Nₚ of the transformer 112 is connected to the first switch element 113 and receives the input DC voltage Vᵢₙ. When the first switch element 113 is alternately conducted or shut off, the transformer 112 can store or release electric energy and thus an increased voltage is induced by the secondary side Nₛ of transformer 112. The rectifier circuit 114 is connected to the secondary side Nₛ of transformer 112. An example of the rectifier circuit 114 includes but is not limited to a diode. The increased voltage induced by the secondary side Nₛ of transformer 112 is rectified by the rectifier circuit 114, thereby outputting the high DC voltage V₁. Please refer to FIG. 1 again. The flyback DC-to-DC converter 11 has only a single first switch element 113 and a single diode. Since less electronic components are included, the circuitry layout and the controlling mechanism are simplified. In addition, since the transformer 112 has only a primary winding assembly, the fabricating cost is reduced. In comparison with the prior art, the power conversion circuit of the present invention is cost-effective and simplified.

In some embodiments, the flyback DC-to-DC converter 11 further includes a feedback circuit 115 and a first control circuit 116. An example of the first control circuit 116 includes but is not limited to a pulse width modulation (PWM) control circuit or a PWM controller. The first control circuit 116 is connected to the feedback circuit 115 and the first switch element 113. The operations of the first switch element 113 are controlled according to a control signal V₂ transmitted from the first control circuit 116.

The feedback circuit 115 is connected to the rectifier circuit 114 and the first control circuit 116. The feedback circuit 115 is used for detecting whether the high DC voltage V₁ outputted from the rectifier circuit 114 is equal to a predetermined voltage value (e.g. 110V). According to the high DC voltage V₁, the feedback circuit 115 issues a feedback signal V_{f} to the first control circuit 116. According to the feedback signal V_{f}, the first control circuit 116 issues the control signal V₂ to control the switching frequency or the duty cycle of the first switch element 113. Due to the inherent property of the flyback DC-to-DC converter 11, by controlling the duty cycle of the switching element at the primary side Nₚ of the transformer 112, the electric energy from the secondary side Nₛ of transformer 112 can be rectified and filtered into a constant high DC voltage with high transient response and high stability. As such, the high DC voltage V₁ outputted from the first-stage power circuit 111 can be adjusted to be equal to the predetermined voltage value. As previously described, the output voltage from the secondary side of the push pull DC-to-DC converter is varied with the change of the input voltage. The use of the flyback DC-to-DC converter according to the present invention can solve this drawback.

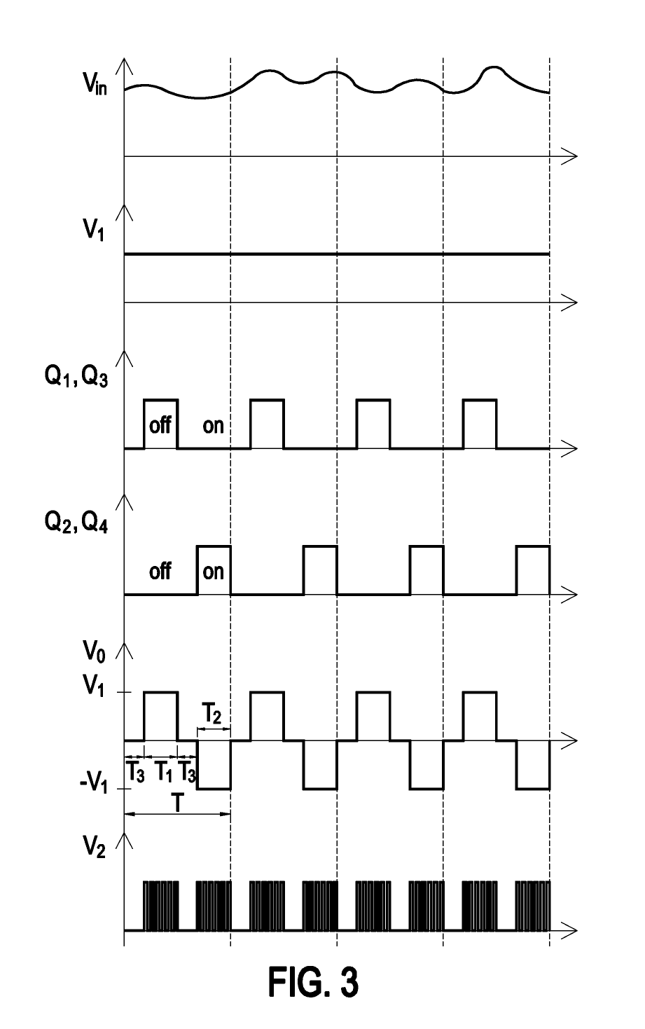

FIG. 3 is a timing waveform diagram illustrating related voltage signals processed in the power conversion circuit as shown in FIG. 2. In the flyback DC-to-DC converter 11 of the power conversion circuit 1, the switching frequency or the duty cycle of the first switch element 113 is controlled according to the feedback signal V_{f} transmitted from the feedback circuit 115 and the control signal V₂ transmitted from the first control circuit 116. By adjusting the switching frequency or the duty cycle of the first switch element 113, the induced voltage at the secondary side Nₛ of transformer 112 and the high DC voltage V₁ outputted from the first-stage power circuit 111 are adjustable. As such, even if the input DC voltage Vᵢₙ is suffered from variation, the constant high DC voltage V₁ can be continuously outputted from the flyback DC-to-DC converter 11. Since the high DC voltage V₁ has high transient response and high stability, the possibility of causing an erroneous operation will be solved.

Please refer to FIG. 2 again. An example of the DC-to-AC converter 13 includes but is not limited to a full bridge DC-to-AC converter. The DC-to-AC converter 13 includes a second-stage power circuit 131 and a second control circuit 132. The second-stage power circuit 131 is connected to the capacitor 12 and the second control circuit 132. The second-stage power circuit 131 includes multiple second switch elements. In this embodiment, the second-stage power circuit 131 includes four second switch elements Q₁, Q₂, Q₃ and Q₄. As shown in FIGS. 2 and 3, in response to a control signal transmitted from the second control circuit 132, the second switch elements Q₁ and Q₃ are simultaneously conducted or shut off, and the second switch elements Q₂ and Q₄ are simultaneously conducted or shut off. For each cycle period T, when Q₁ and Q₃ are conducted (in the on status) but Q₂ and Q₄ are shut off (in the off status), the high DC voltage V₁ with positive polarity (i.e. +V₁) is outputted during the duty cycle T₁. Whereas, when Q₂ and Q₄ are conducted (in the on status) but Q₁ and Q₃ are shut off (in the off status), the high DC voltage V₁ with negative polarity (i.e. −V₁) is outputted during the duty cycle T₂. In such manner, the high DC voltage V₁ is converted into the output AC voltage Vₒ.

Since the input DC voltage Vᵢₙ is converted into the constant high DC voltage V₁ by the flyback DC-to-DC converter 11, if the control signal transmitted from the second control circuit 132 has the constant duty cycle, the output AC voltage Vₒ generated from the second control circuit 132 is maintained at a constant AC voltage level. That is, the effective value of the output AC voltage Vₒ is maintained constant without being altered with a change of the input DC voltage Vᵢₙ. Under this circumstance, the power conversion circuit 1 can provide stable output AC voltage Vₒ to the load.

Please refer to FIGS. 2 and 3 again. According to the waveform, the output AC voltage Vₒ transmitted from the DC-to-AC converter 13 is a modified sine wave AC voltage signal. In some embodiments, when the output AC voltage Vₒ is at the zero voltage level during the time interval T₃, no power is outputted from the power conversion circuit 1. For preventing from abrupt increase of the high DC voltage V₁, the first switch element 113 is disabled under control of the first control circuit 116 during the time interval T₃ such that the flyback DC-to-DC converter 11 will no longer continuously deliver electric energy to the capacitor 12. When the output AC voltage Vₒ is at the −V₁ voltage level during the time interval T₂, the power conversion circuit 1 will output power again. For preventing from abrupt decrease of the high DC voltage V₁, the first switch element 113 is enabled under control of the first control circuit 116 during the time interval T₂. When the first switch element 113 is disabled during the time interval T₃, the power conversion circuit 1 is in a skip mode. According to the controlling mechanism of the present invention, the high DC voltage V₁ can be maintained at a constant and stable voltage level and not altered with the change of the high DC voltage V₁. Since the first-stage power circuit 111 is disabled during the time interval T₃, the power loss of the power conversion circuit is reduced.

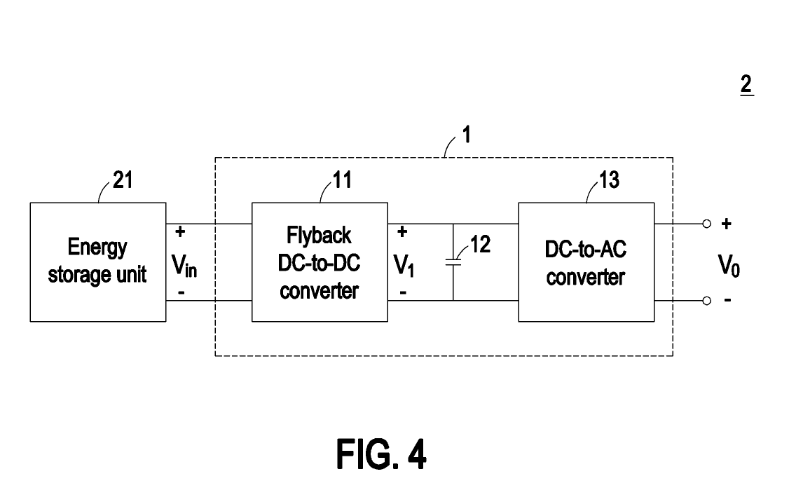

FIG. 4 is a schematic circuit block diagram illustrating a portable power supply having a power conversion circuit of the present invention. As shown in FIG. 4, the portable power supply 2 comprises an energy storage unit 21 and the power conversion circuit 1. An example of the energy storage unit 21 includes but is not limited to a battery for providing the input DC voltage Vᵢₙ. The configurations and the operating principles of the power conversion circuit 1 have been illustrated in FIGS. 1, 2 and 3, and are not redundantly described herein.

Please refer to FIG. 3 again. When the output AC voltage Vₒ is at the zero voltage level during the time interval T₃, the switching operation of the first switch element 113 is stopped and thus the power loss of the power conversion circuit 1 is largely reduced. Under this circumstance, the use life of the energy storage unit 21 can be extended.

From the above description, the power conversion circuit of the present invention uses the flyback DC-to-DC converter to generate the constant high DC voltage, so that the output AC voltage transmitted from the DC-to-AC converter has high transient response and high stability. Since less electronic components are included in the flyback DC-to-DC converter, the circuitry layout and the controlling mechanism are simplified. In addition, since the transformer has only a primary winding assembly, the fabricating cost is reduced. Furthermore, since the switching operation of the first switch element is stopped when the output AC voltage is at the zero voltage level, the power loss of the power conversion circuit is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power conversion circuit comprising:
a flyback DC-to-DC converter for receiving an input DC voltage and converting said input DC voltage into a constant high DC voltage;
a capacitor connected to said flyback DC-to-DC converter for filtering said high DC voltage; and
a DC-to-AC converter connected to said capacitor for converting said filtered high DC voltage into an output AC voltage.

2. The power conversion circuit according to claim 1 wherein said flyback DC-to-DC converter includes a first-stage power circuit, said first-stage power circuit includes a transformer, a first switch element and a rectifier circuit, a primary side of said transformer is connected to said first switch element and receives said input DC voltage, a secondary side of said transformer induces an increased voltage when said first switch element is enabled, and said rectifier circuit is connected to said secondary side of transformer for rectifying said increased voltage into said high DC voltage.

3. The power conversion circuit according to claim 2 wherein said flyback DC-to-DC converter further includes a feedback circuit and a first control circuit, said first control circuit is connected to said feedback circuit and said first switch element, said feedback circuit is connected to said rectifier circuit for detecting said high DC voltage transmitted from said rectifier circuit and generating a feedback signal to said first control circuit according to said high DC voltage, and said first control circuit issues a control signal to control operations of said first switch element according to said feedback signal, so that said high DC voltage is adjusted to be equal to a predetermined voltage value.

4. The power conversion circuit according to claim 3 wherein said DC-to-AC converter includes a second-stage power circuit and a second control circuit, said second-stage power circuit is connected to said capacitor, and said second control circuit is connected to said second-stage power circuit.

5. The power conversion circuit according to claim 4 wherein said second-stage power circuit includes multiple second switch elements, which are conducted or shut off under control of said second control circuit so as to convert said high DC voltage into said output AC voltage.

6. The power conversion circuit according to claim 5 wherein said output AC voltage has a waveform of a modified sine wave AC voltage signal.

7. The power conversion circuit according to claim 6 wherein said first switch element of said first-stage power circuit is disabled under said first control circuit when said modified sine wave AC voltage signal is at a zero voltage level.

8. The power conversion circuit according to claim 1 wherein said DC-to-AC converter is a full bridge DC-to-AC converter.

9. A portable power supply comprising:
an energy storage unit for providing an input DC voltage; and
a power conversion circuit connected to said energy storage unit, and comprising:
a flyback DC-to-DC converter for receiving said input DC voltage and converting said input DC voltage into a constant high DC voltage;
a capacitor connected to said flyback DC-to-DC converter for filtering said high DC voltage; and
a DC-to-AC converter connected to said capacitor for converting said filtered high DC voltage into an output AC voltage.

10. The portable power supply according to claim 9 wherein said flyback DC-to-DC converter includes a first-stage power circuit, said first-stage power circuit includes a transformer, a first switch element and a rectifier circuit, a primary side of said transformer is connected to said first switch element and receives said input DC voltage, a secondary side of said transformer induces an increased voltage when said first switch element is enabled, and said rectifier circuit is connected to said secondary side of transformer for rectifying said increased voltage into said high DC voltage.

11. The portable power supply according to claim 10 wherein said flyback DC-to-DC converter further includes a feedback circuit and a first control circuit, said first control circuit is connected to said feedback circuit and said first switch element, said feedback circuit is connected to said rectifier circuit for detecting said high DC voltage transmitted from said rectifier circuit and generating a feedback signal to said first control circuit according to said high DC voltage, and said first control circuit issues a control signal to control operations of said first switch element according to said feedback signal, so that said high DC voltage is adjusted to be equal to a predetermined voltage value.

12. The portable power supply according to claim 11 wherein said second-stage power circuit includes multiple second switch elements, which are conducted or shut off under control of said second control circuit so as to convert said high DC voltage into said output AC voltage.

13. The portable power supply according to claim 12 wherein said second-stage power circuit includes multiple second switch elements, which are conducted or shut off under control of said second control circuit so as to convert said high DC voltage into said output AC voltage.

14. The portable power supply according to claim 13 wherein said output AC voltage has a waveform of a modified sine wave AC voltage signal.

15. The portable power supply according to claim 14 wherein said first switch element of said first-stage power circuit is disabled under said first control circuit when said modified sine wave AC voltage signal is at a zero voltage level.

16. The portable power supply according to claim 9 wherein said DC-to-AC converter is a full bridge DC-to-AC converter.
